(19) United States
(12) Patent Application Publication
(10) Pub. No.: US 2005/0166365 A1
(43) Pub. Date: Aug. 4, 2005

(54) Pivot joint

(75) Inventor: Jason Hsieh, Taichung County (TW)

Correspondence Address: BACON & THOMAS, PLLC, 625 SLATERS LANE, FOURTH FLOOR, ALEXANDRIA, VA, 22314, US

(73) Assignees: An Puu Hsin Co., Ltd., Taichung (TW); Jason Hsieh, TAICHUNG COUNTY (TW)

(21) Appl. No.: 10/827,231

(22) Filed: Apr. 20, 2004

(30) Foreign Application Priority Data
Feb. 3, 2004 (CN) 2004200030028

(51) Int. Cl. E05D 11/08; E05C 17/64

(52) U.S. Cl. 16/337

(57) ABSTRACT

A pivot joint includes a fixed member, a movable member, two friction pads respectively fastened to the fixed member and the movable member and each having at least one raised portion and one recessed portion formed at its one side, and a pivot shaft inserted through the fixed member, the movable member, and the two friction pads to tightly hold the same by its two ends. The two sides of said two friction pads having the raised and recessed portions are attached to each other. When the movable member is driven by a force to turn with respect to the fixed member for a predetermined angle, the friction pad fastened to the movable member is turned together with the movable member, such that friction resistance is increasingly generated between said raised portions of said friction pads.

### BACKGROUND OF THE INVENTION

1. Field of the Invention

The present invention relates to a joint for fastening two parts together, and more particularly, to a pivot joint for use in an office machine, computer monitor, or the like.

2. Description of the Related Art

There are various kinds of pivot joints for use in different devices subject to their different structure. A pivot joint for use in a photocopier is known comprised of two mounting plates respectively fastened to the machine base of and the cover plate of the photocopier for connection between the machine base of and the cover plate of the photocopier, and a support member for supporting the cover plate while the cover plate is opened away from the machine base. The aforementioned conventional pivot joint commonly includes a large number of parts to be structurally complicated for uneasy production and high production cost.

Therefore, it is desirable to provide a pivot joint, which is inexpensive and easy for production.

### SUMMARY OF THE INVENTION

The present invention has been accomplished under the circumstances in view. It is the main object of the present invention to provide a pivot joint, which has a simple structure and is easy for installation.

It is another object of the present invention to provide a pivot joint, which generates frictional resistance for slowing lowering speed during closing of a movable member with a cover relative to a fixed member of a machine base.

To achieve the foregoing objects of the present invention, the pivot joint of the present invention comprises a fixed member having a pivot hole; a movable member having a pivot hole; two friction pads respectively fastened to the fixed member and the movable member and each having a center through hole, at least one raised portion and one recessed portion formed at its side attached to the other; a pivot shaft inserted through the two pivot holes of the fixed member and the movable member, the center through holes of the two friction pads to tightly hold the fixed member, the two friction pads, and the movable member. When the movable member is driven by a force to turn with respect to the fixed member for a predetermined angle, the friction pad fastened to the movable member is turned together with the movable member, such that friction resistance is increasingly generated between said raised portions of said friction pads.

### BRIEF DESCRIPTION OF THE DRAWINGS

FIG. 1 is an exploded view of a preferred embodiment of the present invention.

FIG. 2 is a perspective side view of the preferred embodiment of the present invention.

FIG. 3 is a sectional view taken along a line 3-3 indicated in FIG. 2.

FIG. 4 is a front view of the preferred embodiment of the present invention.

FIG. 5 is another front view of the preferred embodiment of the present invention at work.

FIG. 6 is a sectional view taken along a line 6-6 indicated in FIG. 5.

### DETAILED DESCRIPTION OF THE INVENTION

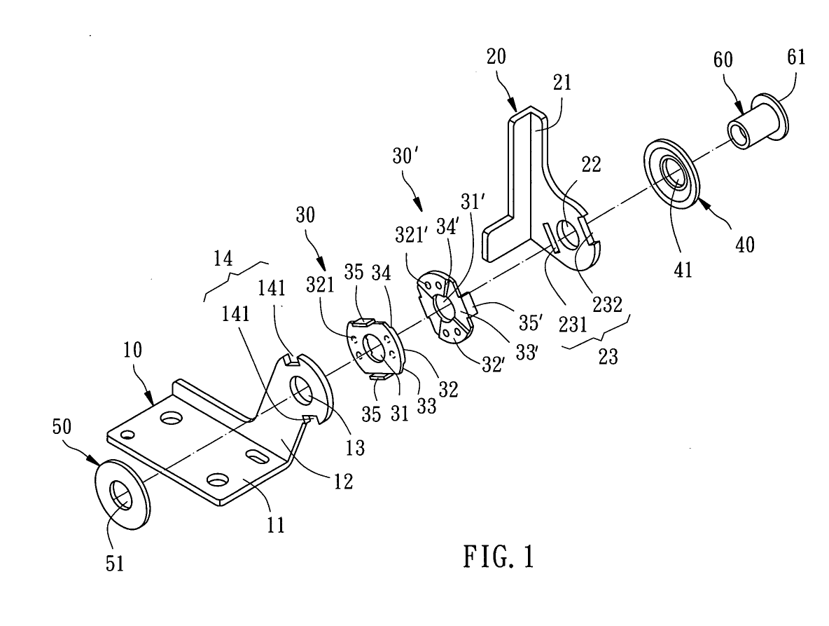

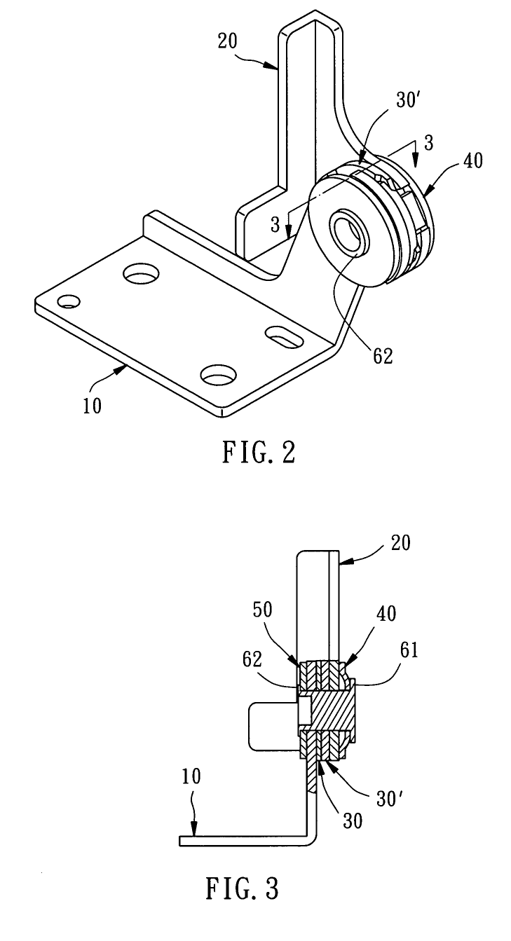

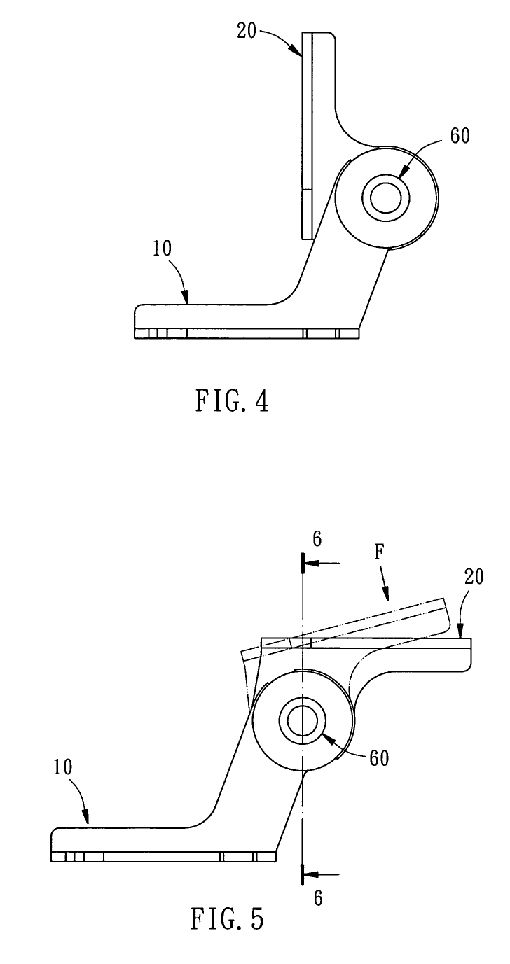

Referring to FIGS. 1-4, a pivot joint constructed according to a preferred embodiment of the present invention is comprised of a fixed member 10, a movable member 20, two friction pads 30 and 30′, a pressure plate 40, a washer 50, and a pivot shaft 60.

The fixed member 10 is an L-shaped rigid plate member including a horizontal wall 11 and a vertical wall 12 perpendicularly extended from a side of the horizontal wall 11, a circular pivot hole 13 running therethrough, and a positioning structure 14 formed in the vertical wall 12. The positioning structure 14 has two locating notches 141 formed at two opposite peripheral edges of the vertical wall 12.

The movable member 20 is an L-shaped rigid plate member including two side walls 21 perpendicular to each other, a circular pivot hole 22 running therethrough and having the same diameter as that of the circular pivot hole 13 of the fixed member 10, and a positioning structure 23 formed at one sidewall 21. The positioning structure 23 has a locating slot 231 and a locating notch 232 formed at two peripheral edges of the one sidewall 21. The circular pivot hole 22 is positioned between the locating slot 231 and the locating notch 232.

Each of the two friction pads, a first friction pad 30 and a second friction pad 30′, is circular and include a center hole 31 (31′), two raised portions 32 (32′) and two recessed portions 33 (33′) both formed at an inner side thereof, a plurality of sloping surface portions 34 (34′) formed between the raised portions 32 (32′) and the recessed portions 33 (33′), two oil holes 321 (321′) formed on the raised portions 32 (32′) and filled with highly viscous lubricant, and a mounting structure embodied as a mounting lug 35 (35′) extended from two peripheral edges corresponding to the recessed portions 33 (33′). During installation, the friction pads 30 and 30′ are put together by that the same sides having the raised portions 32 and 32′ and the recessed portions 33 and 33′ face each other, and then the mounting lugs 35 are respectively engaged into the locating notches 141 of the fixed member 10 and the mounting lugs 35′ are respectively engaged into the locating slot 231 and locating notch 232 of the movable member 20. Thus, the friction pads 30 and 30′ are respectively fastened to the fixed member 10 and the movable member 20 and prohibited from rotary motion relative to the fixed member 10 and movable member 20.

The pressure plate 40 including a center through hole 41 running therethrough and a convex portion formed around the through hole 41 and facing the outside and the center through hole 41 in line with the pivot hole 22 of the movable member 20. The pressure plate 40 is attached to one side of the sidewall 21 of the movable member 20 opposite to the friction pads 30 and 30′. The pressure plate 40 is deformable and of resilience for restoring its shape while being deformed.

The washer 50 is a circular sheet having a circular center through hole 51 running therethrough. The washer 50 is attached to one side of the vertical wall 12 of the fixed member 10 opposite to the friction pads 30 and 30′ with the circular center through hole 51 aligned with the pivot hole 13 of the movable member 10.

The pivot shaft 60 includes a body inserted sequently through the center through hole 41 of the pressure plate 40, the pivot hole 22 of the movable member 20, the center holes 31 and 31′ of the friction pads 30 and 30′, the pivot hole 13 of the movable member 10, and the circular center through hole 51 of the washer 50, a first head 61 and a second head 62 formed at two ends of the body and each having a diameter larger than that of the body and respectively contacting against the convex portion of the pressure plate 40 and a side of the washer 50 to further hold the pressure plate 40, the movable member 20, the friction pads 30 and 30′, the fixed member 10, and the washer 50 together tight.

Referring to FIGS. 1, 3 and 4 again, the raised portions 32 of the first friction pad 30 fastened with the fixed member 10 are respectively engaged into the recessed portions 33′ of the friction pad 30′ fastened with the movable member 20, and the sloping surface portions 34 and 34′ are respectively attached to each other. In the meantime, the fixed member 10 and the movable member 20 are relatively arranged at right angle. The angle can be relatively changed by means of changing the location of the positioning structures of the fixed member and the movable member during fabrication.

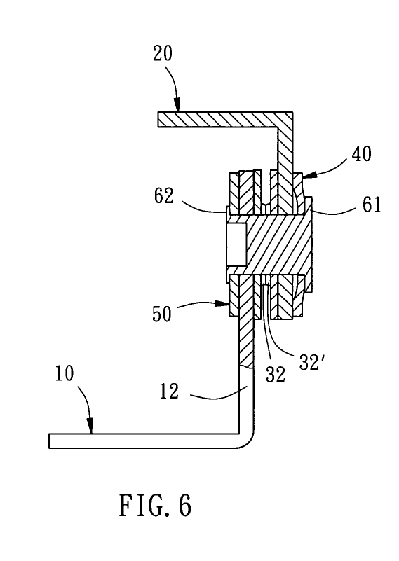

Referring to FIGS. 5 and 6, while turning the movable member 20 relative to the fixed member 10 by an external force F, the friction pad 30′ is turned together with the movable member 20; meanwhile, the two friction pads 30 and 30′ are guided to for rotation with respect to each other by the sloping surface portions 34 and 34′, such that the contact area between the raised portions 32 and 32′ of the friction pads 30 and 30′ is gradually increased to relatively increase space between the fixed member 10 and the movable member 20 (see FIG. 6). Because the distance between the two heads 61 and 62 of the pivot shaft 60 is fixed, increasing the space between the fixed member 10 and the movable member 20 causes the movable member 20 to compress the pressure plate 40 against the first head 61 of the pivot shaft 60, and therefore the friction resistance between the raised portions 32 and 32′ of the friction pads 30 and 30′ is relatively increased. In addition, oil film produced by the viscous lubricant between the raised portions 32 and 32′ slow down downward movement of the movable member 20 relative to the fixed member 10.

As indicated above, by means of the arrangement of the friction pads 30 and 30′ on the pivot shaft 60 between the fixed member 10 and the movable member 20, the movable member 20 can be turned outwards relative to the fixed member 10 to an open position rapidly; however the friction resistance is generated when turning the movable member 20 inwards relative to the fixed member 10 to a close position. When used in an office machine, for example, a photocopier, the fixed member 10 is fixedly fastened to the machine base of the photocopier, and the movable member 20 is affixed to the cover plate of the photocopier. When the cover plate is approaching the machine base during a closing action (as indicated by an imaginary line shown in FIG. 5, the movable member 20 is approaching a horizontal position), resisting force is generated against the downward turning motion of the movable member 20 and the falling pressure of the cover plate, thereby slowing the movement of the movable member 20 and the cover plate. Therefore, the pivot joint prevents sudden falling of the cover plate on the machine base and reduces noise generated while the cover plate and the machine base contact with each other.

1. A pivot joint comprising:
a fixed member having a pivot hole;
a movable member having a pivot hole;
two friction pads respectively fastened to said fixed member and said movable member and each having a center through hole aligned between said two pivot holes of said fixed member and said movable member, and at least one raised portion and one recessed portion formed on a side thereof, said two sides of said two friction pads being attached to each other; and
a pivot shaft inserted through said two pivot holes of said fixed member and said movable member and said center through holes of said two friction pads for tightly interconnecting said fixed member, said two friction pads, and said movable member;
whereby when biasing said movable member is driven by force to turn relative to said fixed member, said friction pad fastened to said movable member is turned together with said movable member, and then said raised portions of said two friction pads are frictionally turned relatively to each other to increasingly generate friction resistance therebetween.

2. The pivot joint as defined in claim 1, wherein said two friction pads each comprise two raised portions and two recessed portions and two sloping surface portions respectively formed between said raised and recessed portions.

3. The pivot joint as defined in claim 2, wherein said two friction pads each further comprise at least one oil hole formed on each of said raised portions thereof and filled with lubricant.

4. The pivot joint as defined in claim 3, wherein said fixed member and said movable member respectively comprises a first positioning structure and a second positioning structure; said two friction pads respectively comprise a first mounting structure and a second mounting structure respectively fastened to said first and second positioning structures, whereby said fixed member and said movable are respectively interconnected with said two friction pads.

5. The pivot joint as defined in claim 4, wherein said first and second positioning structures each comprise at least one locating notch; said first and second mounting structures each comprise at least one mounting lug corresponding to said at least one locating notch.

6. The pivot joint as defined in claim 5 further comprising a pressure plate and a washer, said pressure plate having a circular center through hole and a convex portion formed around said circular center through hole, said pressure plate being positioned at a side of said movable member opposite to said friction pads, said washer having circular center through hole and being positioned at a side of said fixed member opposite said friction pads; said pivot shaft further comprises two heads formed at two ends thereof for respectively stopping and contacting against said convex portion of said pressure plate and said washer.
